(19) United States
(12) Patent Application Publication
(10) Pub. No.: US 2008/0059577 A1
(43) Pub. Date: Mar. 6, 2008

(54) SCALABLE LOGICAL MODEL FOR EDI AND SYSTEM AND METHOD FOR CREATING, MAPPING AND PARSING EDI MESSAGES

(76) Inventors: Suman Kumar Kalia, Maple (CA); Sean Dunne, Dublin (IE); Stephen M. Hanson, Hants (GB); Dominic J. Storey, Eastleigh (GB)

Correspondence Address: HOFFMAN WARNICK & DALESSANDRO LLC, 75 STATE ST, 14TH FLOOR, ALBANY, NY, 12207, US

(21) Appl. No.: 11/470,155

(22) Filed: Sep. 5, 2006

(51) Int. Cl. G06F 15/16

(52) U.S. Cl. 709/204

(57) ABSTRACT

The present invention is a logical model for EDI messages using the open standards XML schema, which is both scalable and high performing which allows the processing of one message at a time. It builds a standard logical instance compliant to XML schema and facilitates standard set of mapping tools working off XML schema to alter or map the EDI messages from one form to another, one message at a time.

### CROSS-REFERENCE TO RELATED APPLICATIONS

This application is related in some aspects to the commonly owned and co-pending application entitled “A Method, System and Schema for Building a Hierarchical Model Schema Definition from a Flat Model Definition”, filed Sep. 5, 2006, assigned attorney docket number CA920060035US1, and assigned Ser. No. (to be provided), the entire contents of which are herein incorporated by reference. This application also is related in some aspects to the commonly owned and co-pending application entitled “Message Validation Model”, filed Sep. 5, 2006, assigned attorney docket number CA920060034US1, and assigned Ser. No. (to be provided), the entire contents of which are herein incorporated by reference. This application is also related in some aspects to commonly owned, and co-pending published patent application number US 2004-0103071 A1, entitled “Meta-Model for Associating Multiple Physical Representations of Logically Equivalent Entities in Messaging and Other Applications”, filed Nov. 6, 2003, and published May 27, 2004, the entire contents of which are herein incorporated by reference.

### FIELD OF THE INVENTION

The present invention relates to a new model for EDI Message Transport and more particularly to a model for the EDI Message Transport which greatly improves performance and scalability of the message definition and mapping tools at tooling time and greatly reduces the parsing time at run-time of each built message.

### BACKGROUND OF THE INVENTION

In large enterprises, there is often a need to share data and generally intercommunicate between many operating systems, platforms, and applications. A stumbling block to the goal of intercommunication is the fact that each different computer system may represent messages using a different message protocol or physical “wire format” (i.e. manner of laying out a message on the wire).

The data transfer can be for a sale, an exchange, or any of the other various types of data transfers related to business transactions. For example, many purchase orders, invoices, and advance shipping notices are sent to and from trading partners over the course of a month or so, whereby these documents are transmitted and received by way of an EDI system provided at each trading partner.

EDI standards were developed over many years to facilitate the exchange of business data and conduct transactions among trading partners. The standards defined a set of commonly used logical definitions in business transactions and described how to build higher level messages by composing these logical definitions. The standards also describe the physical representation of EDI messages on the wire. These logical definitions are called segments in EDI terminology and an EDI message can contain a set of segments.

For background, Electronic Data Interchange (EDI) is the computer-to-computer exchange of choice for structured information, by agreed message standards, from one computer application to another by electronic means and with a minimum of human intervention. In common usage, EDI is understood to mean specific interchange methods agreed upon by national or international standards bodies for the transfer of business transaction data, with one typical application being the automated purchase of goods and services. See http://www.unece.org/trade/untdid/welcome.htm (UN/EDIFACT) and http://www.x12.org/ (ANSI ASC X12) for more information.

Despite being relatively unheralded, in this era of technologies such as XML services, the Internet and the World Wide Web, EDI is still the data format used by the vast majority of electronic commerce transactions in the world. EDI was developed to support business-to-business internal communication, and it has been around approximately for the last twenty-five years. However, EDI is also relevant for company-to-supplier retailer relationships, where the company can be an end-user, a manufacturer, a service organization such as a hospital or a hotel, a governmental organization or a virtual organization.

EDI can be viewed as a set of messages developed for business-to-business communication of electronic data. It works by providing a collection of standard message formats and dictionaries for businesses to exchange data via any electronic messaging service, and is characterized by standardized electronic formats for exchanging business data. Thus, EDI is conveniently used in electronic commerce for the exchange of documents between trading partners in a transaction.

Companies sending and/or receiving EDI data are required to ensure that they have tailored software programs that map between two types of data, one being EDI data and the other being data in a company's internal system formats. Such mapping is a complex process that requires extensive resources and is time consuming.

The basic unit of information in an EDI document is a data. An example of an EDI document is an invoice, a purchase order, or an advance shipping notice (ASN). Each item in the EDI invoice, purchase order or ASN is representative of a data. Each data may represent a singular fact, such as a price, product, model number, and so forth. A string of data s can be grouped together, and is called a data segment, or segment. There can be several data segments per document or message, each having its own use. Each data segment is used for defining a specific item. In addition, an EDI document may include functional groups and transaction sets. Furthermore, an EDI document generally includes addressing information specific to a trading partner.

Translators are used to provide the mapping necessary to read EDI documents. Translators read and parse documents in an EDI format, to generate visual documents for data entry, to translate the EDI to an in-house format, or to change statuses of the data within an application itself.

An EDI interchange is read from a flat file, and then serially processed by a translator. The interchange is the “envelope” by which one or more electronic documents are carried as they traverse the EDI from one company to another company.

However, there is a problem with the present state of the logical model of the EDI message. Extensible Markup Language (XML), a W3C-recommended general-purpose markup language for creating special-purpose markup languages, while becoming quite popular for a number of reasons including that it is easier for humans to read, has messages which can be quite large. (For more information relating to XML, see the W3C XML homepage http://www.w3.org/XML/.) EDI messages, on the other hand, are generally much smaller than XML messages. Because the EDI standard has yet to define the XML format for EDI messages, a number of customers and vendors have attempted to define the XML schema representation for EDI messages and have run into performance and scalability problems. This is because the use of these prior art systems and methods of representing XML schema within EDI messages can make the resulting EDI envelope very large. Each such EDI message may contain hundreds of different message types, with each type containing hundreds of s, for any particular domain (such as banking, transportation, health care and so forth) at tooling time and could contain thousands of instances of such message types at run-time. This leads to performance and scalability problems at:
Tooling time—while defining the EDI envelope messages and creating maps for an envelope containing hundreds of different message types, the entire EDI envelope must be considered and when mapping, messages are mapped to all possible message types causing performance issues;
Run time—due to the very large EDI envelope having the XML schema representation according to prior art methods and systems, excessive memory and processing requirements to handle the EDI envelope having thousands of messages result.

What is needed is a logical model for EDI messages using the open standards XML schema which is both scalable and high performing.

### SUMMARY OF THE INVENTION

The present invention is a logical model for EDI messages using the open standards XML schema which is both scalable and high performing which allows the processing of one message at a time. It builds a standard logical instance compliant to XML schema and facilitates standard set of mapping tools working off XML schema to alter or map the EDI messages from one form to another, one message at a time.

The invention is the creation of new extraneous local s of anonymous complex types, functional group loop (FGL) and transaction set segment loop (TSL) which contain group reference to the functional group and transaction set, respectively. These make the addressing of messages much easier.

The invention further has moved the transaction set header (ST segment) which identifies the EDI message and the transaction set trailer (SE segment) from within the EDI message as per the standard to outside of the EDI message to within the transaction group.

The invention further is the creation of a container EmbeddedMessageGroup which contains the EDI modeled message in the Message Model.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 is a block diagram showing the general components of a computer system that can be used to run an EDI Document Object Model, or EDI DOM, (hereinafter also referred to as “model”), according to an embodiment of the present invention;

FIG. 2 is a block diagram showing a hierarchical memory representation of an EDI document that is provided by way of an EDI DOM according to an embodiment of the present invention;

FIG. 3 is a block diagram of an EDI Message Transport according to an embodiment of the present invention;

FIG. 4 shows logical model schema definition for an IBM 856 Message Definition of an EDI envelope according to an embodiment of the present invention; and

FIG. 5 is the sample instance document for an EDI interchange. The interchange contains 2 functional groups. Functional group 1 contains 2 instances of transaction sets each containing message m_{—}856 and functional group 2 contains model.

### DETAILED DESCRIPTION OF THE INVENTION

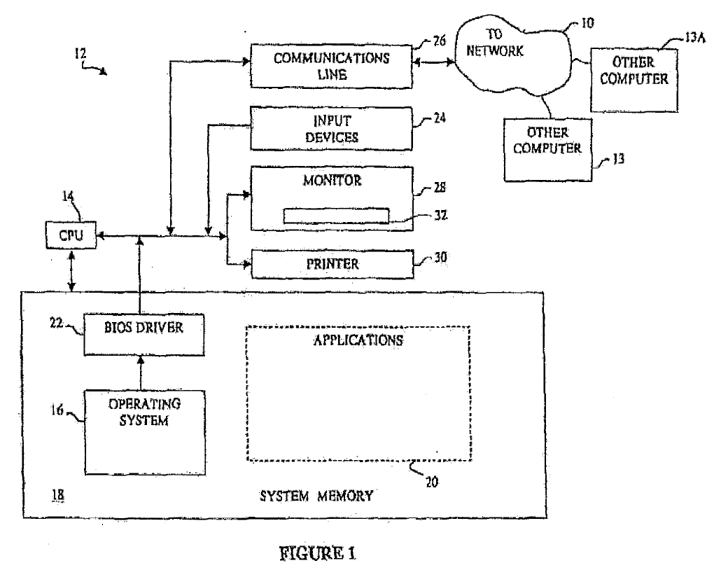

With reference to the accompanying drawings, a detailed description of the present invention will be provided. FIG. 1 is a block diagram showing the components of a general-purpose computer system 12 connected to an electronic network 10, such as a computer network. The computer network 10 can also be a public network, such as the Internet or Metropolitan Area Network (MAN), or other private network, such as a corporate Local Area Network (LAN) or Wide Area Network (WAN), or a virtual private network (VPN). As shown in FIG. 1, the computer system 12 includes a central processing unit (CPU) 14 connected to a system memory 18. The system memory 18 typically contains an operating system 16, a BIOS (basic input/output system) driver 22, and application programs 20. In addition, the computer system 12 contains input devices 24 such as a mouse and a keyboard 32, and output devices such as a printer 30 and a display monitor 28.

The computer system generally includes a communications interface 26, such as an Ethernet card, to communicate to the electronic network 10. Other computer systems 13 and 13A may also be connected to the electronic network 10. One skilled in the art would recognize that the above system describes the typical components of a computer system connected to an electronic network. It should be appreciated that many other similar configurations are within the abilities of one skilled in the art and all of these configurations could be used with the methods of the present invention.

In addition, one skilled in the art would recognize that the “computer” implemented invention described further herein may include components that are not computers per se but include devices such as Internet appliances and Programmable Logic Controllers (PLCs) that may be used to provide one or more of the functionalities discussed herein. Furthermore, “electronic” networks are generically used to refer to the communications network connecting the processing sites of the present invention, including implementation by using optical or other equivalent technologies.

One skilled in the art would recognize that other system configurations and data structures and electronic/data signals could be provided to implement the functionality of the present invention. All such configurations and data structures are considered to be within the scope of the present invention.

The present invention is directed to an EDI Document Object Model, or EDI DOM, (hereinafter also referred to as “model”), which allows for an electronic interchange document. With such a model, various types of client software and applications can be utilized in order to manipulate, extract, and set segment, and/or sub-information stored within the model as well as create matching schema (meta message definition). This allows one to readily generate an interchange or document from the model at run-time which may be mapped/transformed to another structure. That is, a user is able to parse and pull particular information from a first electronic document, whereby that information may correspond to segment data, data or sub-data, and pull that information into a second electronic document in the same EDI format or in another EDI format.

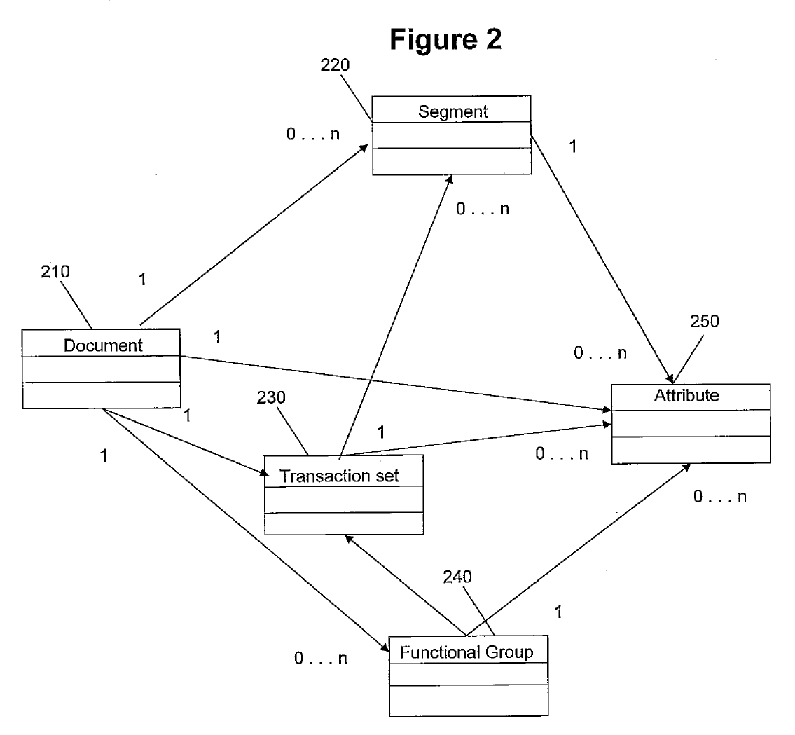

The EDI DOM contains the classes or objects that serve as a container for EDI document s. The overall object model is shown in FIG. 2, and includes a Document class (or object), a Segment class (or object), a Functional Group class (or object), a Transaction Set class (or object), and a Data/Attribute class (or object).

EDI documents are represented as a collection of attributes, segments, functional groups and transaction sets.

Referring now to FIG. 2, the Document class 210 represents an EDI document as a collection of attributes, segments, functional groups, and transaction sets. The Document class 210 is the root node of the DOM-style representation of an EDI document according to the invention, whereby a document is represented in the EDI DOM as a collection of the fundamental entities of the document.

The fundamental entities of an EDI document, which is represented by a Document node 210 in FIG. 2, are: 1) a single interchange envelope by which the EDI document is sent from one company to another company; 2) zero or more interchange control segments, as indicated by zero or more interchange control segment nodes 220; 3) zero or more transaction sets contained within a functional group, as indicated by zero or more transaction set nodes 230; and 4) zero or more functional groups containing one or more transaction sets, as indicated by zero or more functional group nodes 240. The data for each node is stored in memory, whereby data for a node can be retrieved from the memory in a manner known to those skilled in the art with respect to memory data retrieval. Transaction set nodes can occur in an EDI document apart from their inclusion in a functional group. In other words, hierarchically speaking, an EDI document can contain zero or more “independent” transaction sets plus zero or more functional groups, which contain one or more transaction sets.

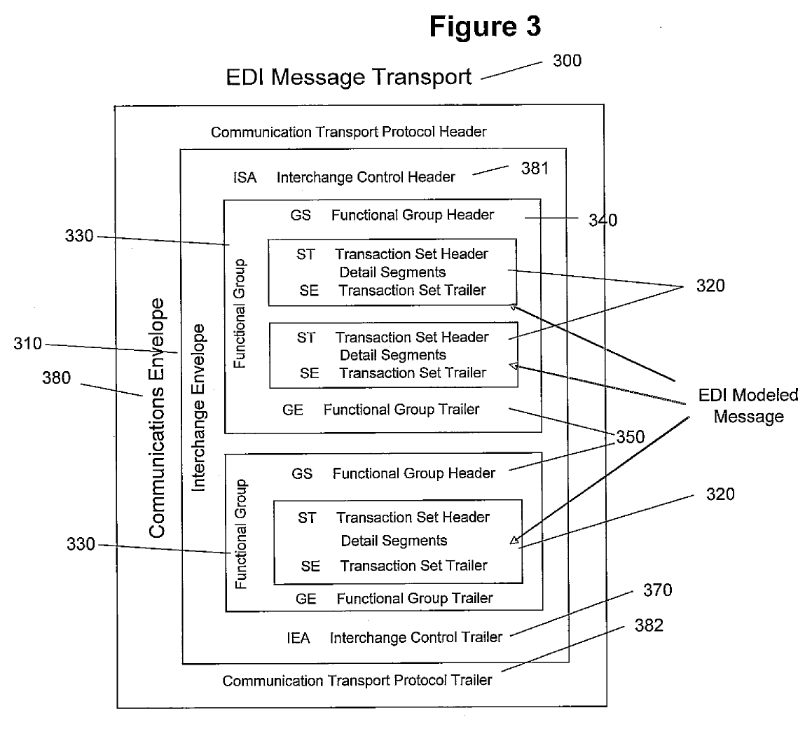

FIG. 3 shows the EDI Message transport 300 and the structure of EDI interchange envelope 310 in block diagram form. The transmission of data proceeds according to very strict format rules to ensure integrity and maintain the efficiency of the interchange. Each business grouping of data is called a transaction set 320 which contains a group of logically related data in units called segments. Similar transaction sets called “functional groups” 330 can be sent together within a transmission. Each functional group is prefaced by a group start or header segment 340 and is terminated by a group trailer segment 350. One or more functional groups are prefaced by an Interchange header 360 and followed by an interchange trailer 370 within the Interchange Envelope 310. The Interchange Envelope 310 is within the Communications Envelope 380 having a Communications Transport Protocol Header 381 and a Communications Transport Protocol Trailer 382.

The present invention describes a model for EDI messages using the Websphere Business Integration Message Broker (WBIMB) message model. This model is described in related co-pending US patent application entitled “Meta-model for associating multiple physical representations of logically equivalent entities in messaging and other applications”, filed on May 27, 2004, Ser. No. 10/703,037 and is herein incorporated by reference.

The logical structure of EDI messages is defined using the standard W3C XML Schema model and physical representations are defined using the Tagged/Delimited String (TDS) format. The standard W3C XML schema model is defined in the open-source document: http://dev.eclipse.org/viewcvs/indextech.cgi/.about.checkout.about./xsd-h-ome/docs/javadoc/org/eclipse/xsd/package-summary.html#details (accessible via http://www.eclipse.org/xsd). For a description of XML schemas generally, the reader is referred to the text XML Applications by Frank Boumphrey et al., 1998, Wrox Press, which text is hereby incorporated by reference herein. The XML schema recommendation is available at http://www.w3c.org/TR/xmlschema-0/ (“XML Schema Part 0: Primer”), http://www.w3c.org/TR/xmischema-1/(“XML Schema Part 1: Structures”, and http://www.w3c.org/TR/xmlschema-2/(“XML Schema Part 2: Datatypes”). The TDS format is described in detail at http://publib.boulder.ibm.com/infocenter/wmbhelp/v6r0m0/index.jsp?topic=/com.ibm.etools.mft.doc/ad00800_.htm, such readings are incorporated here by reference.

The model and techniques of the present invention exploit the advanced capabilities of WBIMB message model to create a definition for EDI envelope and messages which scales and performs well both at tooling and run time. The present invention relates specifically in defining the logical structure of the EDI envelope containing EDI messages. The physical representations are standard TDS format descriptions (see reference noted above) and won't be described further in the specification.

Table 1 below defines the Logical Model Representation of EDI Constructs. For definitions of the various constructs, the reader is referred to the W3 Schools web site available at: http://www.w3schools.com/xml/default.asp for reference. Also for reference, below identifies the EDI construct abbreviations:

### ISA—Interchange Control Header

### GS—Function Group Header

### ST—Transaction Set Header

### SE—Transaction Group Trailer

### GE—Function Group Trailer

### IEA—Interchange Control Trailer

TABLE 1
Logical Model Representation of EDI Constructs

```
Segment
Segment is represented as global of complex types which contain Data s
(Note: Global s and s are immediate children of the “schema”. Local s is nested within a
complex type or group. A complex type is an XML that contains other s and/or
attributes.)
Data
Data is modeled as local of simple or anonymous complex types within the segment
(Note: A definition for “anonymous types” may be found at the following address:
http://www.w3.org/TR/xmlschema-0/#InlineTypDefn)
        The simple types map naturally to the schema types
            When there is not an exact match; the extra information as
            required will be carried in the physical model. E.g. in some cases
            date or time fields which can optionally be coded in more than one
            format (HHMM or HHMMSS, that is, hours, minutes, seconds)
            may have to be modeled as string in the logical model and the
            format information carried in the physical layer.
        Data can be Mandatory, Optional, Situational or Relational
          Mandatory and Optional: handled through minOccurs (or
          minimum number of occurrences) construct of schema
          Situational or Relational: their presence depends upon the
          presence of another
              represented as optional in schema with minOccurs = 0
              Situational/Relational rules modeled through Message
              Validation Model (Invention Disclosure submitted - number
              to be assigned)
          Data has a name (reference designator which follow the convention
          SegmentName<SequenceNo>) and ID (which is of type integer)
    Composite in EDI terminology is a Data that contains other Data s. This map to
    a local of anonymous complex type which contains local s.
Segment Groups
Segment Groups are represented as xsd:group and it contains references to segments
Transaction Set
Transaction Set is modeled as xsd:group and contains a group reference to
EmbeddedMessageGroup with maxOccurs (maximum number of occurrences) set
to 1.
          EmbeddedMessageGroup: It is the container that contains the EDI
          modeled message in the Message Model.
    Represented in Message Model as xsd:group with contentKind set to
    OpenDefined and composition set to Message. It contains the EDI modeled
    message as defined by the EDI standard or customized by the user. Modeling it
    as OpenDefined permits imbedding of any EDI message within the group. This
    concept is analogous to schema group which contains only xsd:any restricted to a
    set of namespaces. For detailed description of contentKind and composition,
    please refer to the co-pending US patent application entitled “Meta-model for
    associating multiple physical representations of logically equivalent entities in
    messaging and other applications”, filed on May 27, 2004, Ser. No.
    10/703,037
    EDI message is represented as global of anonymous complex type. The general
structure of EDI message complex type is as follows:
      Header: contains a set of segments
          Represented as local schema group
          As per EDI standard it contains first segment ST which contains the
          message identifier
      Details: contains a set of segments
          Represented as local schema group
          Contains segments specific to the message
          Can contain one or more segment loops or nested segment loops
          which are modeled as
              Local of anonymous complex types which contain
                  references to segments
                  local s of anonymous complex types (for nested loops)
                  which in turn contain segments or local s for loops
                  min/maxOccurs on the local determines cardinality of
                  loop
      Trailer: contains a set of segments
          Represented as local schema group
          As per the EDI standard it contains last segment SE which marks the
          end of the message
Note:
      1. Segments are included by references in the Header, Details and Trailer.
      EDI Standard documents refer to these as tables.
      2. Each included segment carries a position no
Functional Group
Functional Group is modeled as global xsd:group containing GS segment, followed by
TSL (Transaction Set Loop with maxOccurs set to −1) containing a group reference to
TransactionSet group, followed by GE segment.
```

As seen above, Table 1 illustrates the EDI constructs that are used in the logical model of the present invention for EDI messages using the open standards XML schema. The XML schema used for the EDI constructs are well known making it easy to program. The use of these EDI constructs allows one to build a standard logical instance compliant to XML schema and facilitates standard set of mapping tools working off XML schema to alter or map the EDI messages from one form to another, one message at a time. The present invention introduces, to the EDI Transaction Set construct, a schema group called EmbeddedMessageGroup. EmbeddedMessageGroup is a container for containing the EDI modeled message in the Message Model. It is modeled as well-known XML schema xsd:group with contentKind set to OpenDefined and composition set to Message. It contains the EDI modeled message as defined by the EDI standard or as customized by the user. As well documented in co-pending US patent application entitled “Meta-model for associating multiple physical representations of logically equivalent entities in messaging and other applications”, filed on May 27, 2004, Ser. No. 10/703,037, the content attribute is specific to messaging applications and is not expressly defined in the W3C XML Schema recommendation referenced above. This attribute has three enumerations representing alternative types of constraints of a message's s that may be applicable to a message received “on the wire.” The added enumerations provide a mechanism for use by a developer of tools which convert messages between alternative wire formats for indicating that it is acceptable if additional s exists in a message bit stream as long as it has all the s as defined in the logical model in the appropriate order. That is, the enumerations may be used to indicate that a particular message should match a partial message definition of the logical model when it is received, and in the case where the received message has additional s, the additional s may be ignored or processed by applications that are aware of the presence of additional s.

The three added content type enumerations are:

1. Closed—Default enumeration indicating that a message bit stream is to match the definition of the message in the logical model exactly (as implicitly defined in the XML Schema recommendation);

2. Open Defined—indicates that a message bit stream can contain any s which have been defined in the relevant message set (defined below); and

3. Open—the message bit stream can contain any s, even those that have been defined in different message sets.

The composition attribute extends the standard composition type attribute supported by XML schemas with enumerations useful for messaging applications, which enumerations are indicative of possible composition types for physical messages. The composition kind attribute extends the standard composition types of XML schemas (choice, sequence, and all) with the following two added enumerations:

1. Unordered Set—similar to “sequence” (which requires all s of a message to appear in sequence) except that s within the set may occur in any order.

2. Message—a restricted form of “choice” in which a complex type may have references only to those global s for which a message has been defined in the relevant message set.

Modeling EmbeddedMessageGroup as OpenDefined permits embedding of any EDI message within the group. This concept is analogous to a schema group which contains only xsd:any restricted to a set of namespaces.

Within EDI Interchange Envelope, Functional groups and Transaction sets are modeled as segment loops of unbounded cardinality. As a result, extraneous local s of anonymous complex types, FGL for functional group loop and TSL for transaction set loop, are introduced in the logical model which contain group reference to a corresponding Functional group and Transaction set respectively. An extraneous local is a local of complex type which repeats as many times as the number of Functional Groups modeled by the user in an interchange or number of Transaction Sets (modeled by the user) in a Functional Group. The complex type for the contains a group reference to Functional Group or the Transaction Set.

The present invention also introduces a new concept of having the ST segment (transaction set header which identifies the EDI message) and the SE segment (transaction set trailer) as being included in the Transaction Set group—instead of being part of the EDI Message as per the EDI standard.

This approach has the following advantages (among others):
It allows the user to write simple parsers without having a look ahead capability because the message key identifying the message embedded in the following group is available in the ST segment before the parsing of the message can begin. In prior art systems, the ST segment is included within the message requiring the parsers to peek into the input stream to determine message type.
As can be seen in the following instance document, the message is clearly contained. This will be discussed further.
It allows easy writing of unambiguous XPATH or ESQL path statements to reference s within the instance document. This will be discussed further.

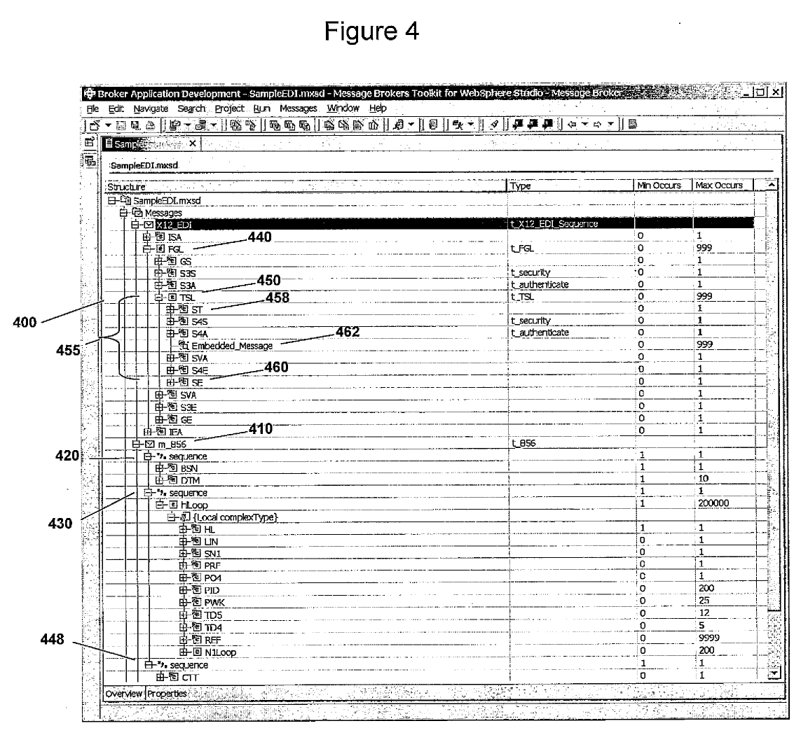

Referring now to FIG. 4, a sample EDI Interchange Envelope 400 is shown. Message m_{—}856 410 has a header 420 and details 430. The trailer for Message m_{—}856 is shown as 448. Functional Group Loop (FGL) 440 is shown as an extraneous as is Transaction Set Loop (TSL) 450. Within the Transaction Set group 455, are the ST 458 and the SE 460 clearly outside of the EDI message (m_{—}856 410 in this example) instead of within the EDI message as per the EDI standard. Also within the Transaction Set group 455 is new EDI construct EmbeddedMessageGroup 462.

As noted earlier, the creation of the new extraneous local s of anonymous complex types, functional group loop (FGL) and transaction set segment loop (TSL) which contain group reference to the functional group and transaction set, respectively, makes the addressing of messages much easier, that is, it makes it easy to write unambiguous XPATH or ESQL path statements to reference s within an instance document. This will be discussed further below.

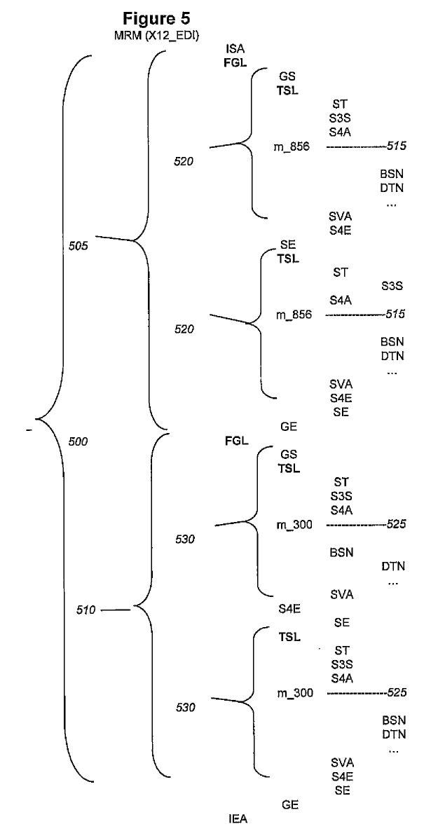

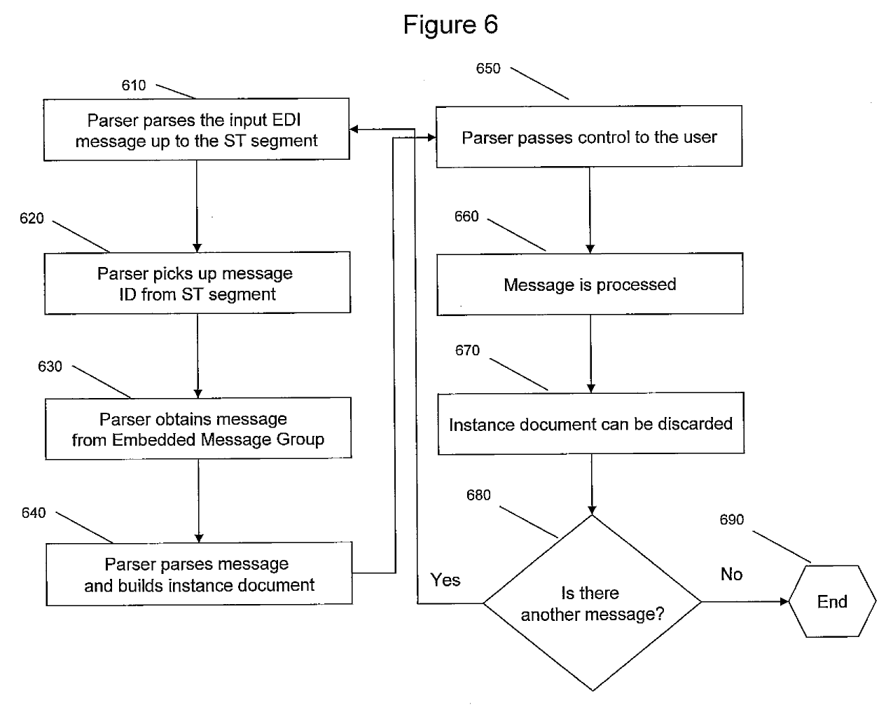

Referring now to FIG. 5, an instance diagram shows the Logical Message Tree at runtime for X12 interchange for each of the alternatives. The interchange 500 contains 2 functional groups 505 and 510. Functional group 1 505 contains 2 instances of message m_{—}856 515 within transaction sets 520 while functional group 2 510 contains 2 instances of message m_{—}300 525 within transaction sets 530. As can be seen from this example of an instance document, the messages and transaction sets are contained within the respective groups and within the interchange envelope. Also, the use of the TSL construct allows for easier addressing. This will be shown below in the following two examples.

The first example is that of an ESQL path statement which references s within an instance document. ESQL (Embedded SQL) is based on Structured Query Language (SQL), which is commonly used to query relational databases like DB2 Universal Database. A user can define the logic of message flows using ESQL by inserting ESQL code into built-in nodes that are supplied with the IBM WebSphere Message Broker, such as the Compute node, Database node, and Filter node. For more information regarding ESQL, the reader should reference IBM Redbook entitled “Websphere Message Broker Basics” having an ISBN of 0738494372 and an IBM Form Number of SG24-7137-00. It should be noted that the Websphere® Message Broker product (MRM domain), while creating an instance document for the message, strips of the top level and sticks the parsed tree under the InputRoot.MRM. Also noted is that ESQL paths are used in the Websphere® Message Broker product to reference s in the message instance built by the parser.

Referring back to FIG. 5, for the second m_{—}300 message 525, the ESQL message path is:

InputRoot.MRM.FGL[2].TSL[2].m_{—}300

For the associated ST segment, the ESQL message path is:

InputRoot.MRM.FGL[2].TSL[2].ST

For the associated GS segment, the ESQL message path is:

InputRoot.MRM.FGL[2].GS

### The indices are applied to the group that repeats.

The second example is that of an XPATH path statement which references s within an instance document. XPATH (XML Path Language) is a terse (non-XML) syntax for addressing portions of a document. For more information, the reader should reference W3C Recommendation 16 Nov. 1999 (XML Path Language (XPATH) Version 1.0 located at http://www.w3.org/TR/xpath.

Referring back to FIG. 5, for the second m_{—}300 message 525, the XPATH message path is:

X12_EDI.FGL[2].TSL[2].m_{—}300

For the associated ST segment, the XPATH message path is:

### X12_EDI.FGL[2].TSL[2].ST

For the associated GS segment, the XPATH message path is:

X12_EDI.FGL[2].GS

### The indices are applied to the group that repeats.

Referring now to FIG. 6, the process at runtime is illustrated to show how the new Scalable Logical Model for EDI reduces common bottleneck at the parse stage. At step 610, the parser parses the input EDI message up to the ST (Start Transaction) segment within the Transaction set group. At step 620, the parser picks up the message identifier from the ST segment, identifies its type and, at step 630, obtains the message from the EmbeddedMessageGroup container. At step 640, the parser parses the message and builds the corresponding instance document. At step 650, the parser passes control to the user and, at step 660, the message is processed. At step 670, the instance document can be discarded and, at step 680, it is determined whether there is another message. If there is, the process re-commences at step 610 or, if not, the process ends. With this approach of parsing and processing only one message at a time, the entire EDI Interchange Envelope does not have to be built in entirety in memory and, as a result, a very large EDI interchange containing many large message can be processed quickly and efficiently. This reduces a common processing bottleneck at the parse stage. Furthermore, it allows the user to write simple parsers without having a look ahead capability because the message key identifying the message embedded in the following group is available in the ST segment before the parsing of the message can begin. In prior art systems, the ST segment is included within the message requiring the parsers to peek into the input stream to determine message type thereby requiring more complex parsers.

In tool time period, since none of the EDI messages are defined in-line within the EDI Interchange envelope, its structure becomes very simple and small containing only a few set of elements pertaining to segments which surround the EDI Message. The EDI interchange envelope contains a logical container “Embedded Message Group” whose contentKind is set to openDefined (which is roughly equivalent to xsd:any construct of XML Schema), it allows any type of EDI message to be contained/substituted in the group at runtime. At tool time, users can create definition of EDI message type independent of the EDI Interchange envelope and map for mapping one EDI message to another. While creating maps, the expanded source and target trees contain definitions of only the EDI messages being mapped instead of all the possible different message types. This greatly improves performance and scalability of the message definition and mapping tools.

To give an illusion to the user that, he is mapping one EDI envelope to another, UI tools can expand the source and target trees up to the point of “Embedded Message Group” and then show a dialog to select a message from a given list of EDI message name and then expand the tree for the selected message only.

The invention can take the form of an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/Output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. An EDI message model comprising an Interchange Envelope comprising one or more Transaction sets, each Transaction set having an EDI message section having a header portion comprising a set of segments, having a details portion comprising a set of segments representing the message, and a trailer portion comprising a set of segments, a transaction set loop containing a group reference to the Transaction Set group.

2. The EDI message model of claim 1, further comprising one or more Functional Groups, wherein each Functional Group includes one or more of the one or more Transaction set loops, a functional group loop (FGL) containing a group reference to the Functional Group.

3. The EDI message model of claim 2, wherein the FGL and the TSL are extraneous local s (having unbounded cardinality) of complex types, the complex type for FGL and TSL contain a group reference to the functional group and transaction set group respectively.

4. The EDI message model of claim 1, wherein each transaction set further has a transaction set header (ST) identifying the EDI Message and a transaction set trailer (SE), both ST and SE being located outside the EDI message section.

5. An EDI message model comprising an Interchange Envelope comprising: one or more Transaction sets, each Transaction set having an EDI message section having a header portion comprising a set of segments, having a details portion comprising a set of segments representing the message, and a trailer portion comprising a set of segments, and each Transaction set further a transaction set header segment (ST) and a transaction set trailer (SE), the ST and SE being outside of the EDI message section.

6. The EDI message model of claim 5, wherein each transaction set further comprises a Embedded Message Group container located between ST and SE and outside of the EDI message section, the container containing the message model as defined by the EDI standard or as customized by the user.

7. The EDI message model of claim 6, wherein the container (Embedded Message Group) is modeled so that it permits the embedding of any EDI message type within it.

8. The EDI message model of claim 7, further comprising one or more Functional Groups, wherein each Functional Group includes one or more of the Transaction sets (by including transaction set loop, a functional group loop (FGL) containing a group reference to the one or more Functional Group

9. A process for parsing a message, the message comprising an Interchange Envelope comprising one or more Transaction sets, each Transaction set having an EDI message section having a header portion comprising a set of segments, having a details portion comprising a set of segments representing the message, and a trailer portion comprising a set of segments, and each Transaction set further a transaction set header segment (ST) and a transaction set trailer (SE), the ST and SE being outside of the EDI message section, each transaction set further comprises a Embedded Message group container located between ST and SE and outside of the EDI message section, the container containing the message model as defined by the EDI standard or as customized by the user, wherein the container is modeled so that it permits the embedding of any EDI message type within it, the process comprising:
parsing the message up to the ST segment;
picking up the message identifier from the ST segment and determining its type;
obtaining message from the container;
parsing message;
building instance document; and
processing message.

10. The process of claim 9, further comprising discarding the instance document after the processing message step.

11. The process of claim 10, further comprising determining if there is another message to process after the discarding the instance document step.
